(19) United States
(12) Patent Application Publication
(10) Pub. No.: US 2026/0187113 A1
(43) Pub. Date: Jul. 2, 2026

(54) HYBRID CONTENT GENERATION FOR CORRECTING ARTIFICIAL INTELLIGENCE MODELS

(71) Applicant: American Express Travel Related Services Company, Inc., New York, NY (US)

(72) Inventors: Alaric M. EBY, Scottsdale, AZ (US); Dagen WANG, Houston, TX (US)

(73) Assignee: American Express Travel Related Services Company, Inc., New York, NY (US)

(21) Appl. No.: 19/007,303

(22) Filed: Dec. 31, 2024

(51) Int. Cl. G06F 16/3329; G06F 16/3331; G06F 16/35

(52) U.S. Cl. CPC G06F 16/33295; G06F 16/3331; G06F 16/35

(57) ABSTRACT

Disclosed herein are system, method, and computer program product embodiments for generating corrective contents. For example, the method includes identifying noise content in responses of a large language model (LLM), determining a theme for corrective contents to counter the noise contents, determining a target genre distribution for the corrective contents, generating, using an artificial intelligence (AI) model, the corrective contents based on the target genre distribution and the theme, and transmitting the corrective contents via one or more channels.

### TECHNICAL FIELD

Aspects relate to systems and methods for correcting trained machine learning models using hybrid generated contents.

### BACKGROUND

Generative artificial intelligence (AI) and large language models (LLMs) (e.g., Generative Pre-trained Transforms (GPTs)) hold enormous promise. This technology has already changed the way humans interact with computers because LLMs/GPTs can generate novel human-like content based on inputs and/or prompts that can mimic the creativity and ingenuity of humans.

Misinformation, bias, paid promotion, and other informational challenges can distort trained LLMs and GenAI, which can lead to inaccurate, false, misleading results. With increasing numbers of users relying on GenAI and LLMs as a first source of information, they have critical influence in customer perception, how brands are perceived, and overall information quality online. The technical problem is that once GenAI and LLMs are trained, it becomes very difficult to correct outputs from a trained model. This is contrast to search results, such as through a search engine, there are measures for a merchant to update search results.

### SUMMARY

Aspects of this disclosure are directed to systems and methods for correcting trained machine learning models using hybrid generated content. Hybrid generated content may refer to content generated by artificial intelligence models that include various content types including text, visuals, interactive elements, and the like. For example, the method includes identifying noise content in responses of a large language model (LLM), determining a theme for corrective contents to counter the noise content, determining a target genre distribution for the corrective contents, generating, using an artificial intelligence (AI) model, the corrective contents based on the target genre distribution and the theme, and broadcasting the corrective contents via one or more channels such that the LLM is trained using the corrective contents.

Certain aspects of the disclosure have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

The accompanying drawings, which are incorporated herein and form a part of the specification, illustrate aspects of the present disclosure and, together with the description, further serve to explain the principles of the disclosure and to enable a person skilled in the art to make and use the aspects.

FIG. 1 is a block diagram of an environment for a system for generating contents for a large language model (LLM), in accordance with an embodiment of the present disclosure.

FIG. 2 is a diagram that shows a processing flow for generating and publishing corrective contents for LLMs, in accordance with an embodiment of the present disclosure.

FIG. 3 is an example method for retraining a trained machine learning models using hybrid generated contents, in accordance with an embodiment of the present disclosure.

FIG. 4 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Aspects of the present disclosure relate to a system for correcting trained machine learning models using hybrid generated content. In particular, the present disclosure relates to generating corrective contents for a large language model (LLM) to minimize noise content in responses of the LLM. The corrective contents may be published across one or more network channels too one or more network locations for hosting the corrective contents. The LLM may automatically retrain using the corrective contents. Hybrid contents refer to content of different genres.

As described in the background, misinformation, fake news, outdated data, and the like (collectively referred herein as noise content) may affect responses from LLM models causing them to generate outputs that contain incorrect, misleading, and/or inaccurate information. With increasing numbers of users relying on LLMs as a first source of information, they have critical influence in customer perception and overall information quality online. What is needed is a system that can timely correct the model (e.g., retraining) when it is determined that any noise content has been used as inputs for training the model. Conventional models cannot be updated in a timely fashion as it may take a period of time before the LLM learns that it has been trained on noise content, the approaches described herein correct for noise contents by providing retraining of the LLM. In some embodiments, retraining may occur after the LLM has been deployed. Ion some embodiments, retraining may occur during a model development stage when the LLM is being actively and generating outputs that are based on the noise content and specific inputs.

The disclosure provides a solution for the technological problem of generating accurate responses from an existing LLM by improving the training of the LLM. The accuracy of the responses is improved by providing live training of the existing LLM by influencing the LLM in a noisy environment. Ways to influence the source knowledge and training activity of major model providers are identified and corrective contents is generated. The corrective contents act as ground truth data for the LLM. Thus, responses from the LLM are more accurate as they do not include the noise content.

The approaches described herein provides the advantage of dynamically retraining models to mitigate the impact of prior training using noise content and publishing corrective content through internal and external parties. In addition, a feedback loop is provided to improve the efficiency of the published contents. Further, correction for the noise contents is done without requiring direct intervention or approval from the LLM provider.

In some aspects, the system described herein may perform a corrective action to correct the impact of noise content on models. The corrective action may include publishing contents to correct the noise content. The corrective action may correct the image of brands or users and misinformation housed within LLMs. The LLM may train on the published contents though a fine-tuning process where a trained LLM is further trained on a specific dataset that may include new web content. By providing the corrective contents for the LLM to train on, the model accuracy is improved. The responses from the LLM are more accurate and the number of outputs that contain incorrect, misleading, and/or inaccurate information is reduced.

In some aspects, the system may determine a theme of what it is desired to be delivered to customers. Based on the theme, the system may generate the corrective content. The corrective content may be of different forms (e.g., blogs, videos, chats). The theme may refer to contents that counters the noise content or any message that it is desired to be promoted. For example, if a company is a travel company and then rebrands as an artificial intelligence company, the LLM may still output that the company is a travel company even after rebranding. The theme for the corrective contents may be contents that describes the company as an AI company.

Various embodiments of these features will now be discussed with respect to the corresponding figures. Although the embodiments are described as for large language models, it is understood that the approaches described herein may be used to generate contents for other artificial intelligence models (e.g., generative artificial intelligence models).

### System Overview and Function

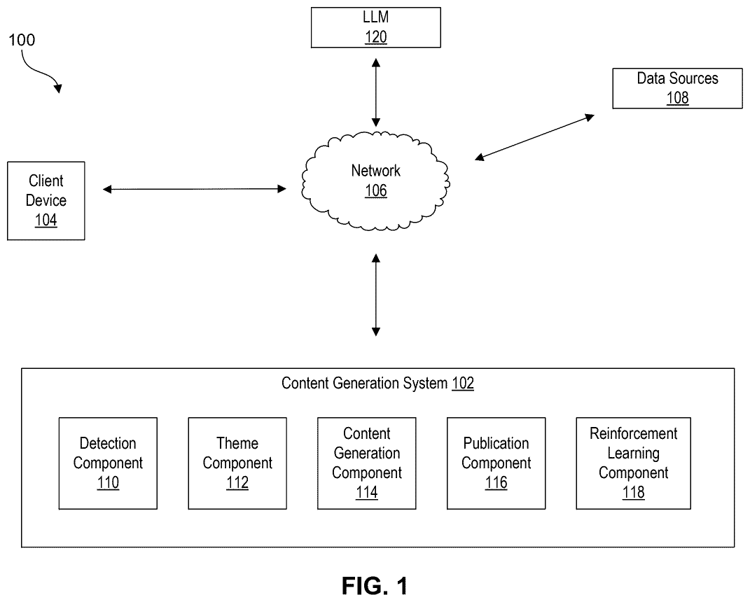

FIG. 1 is a block diagram of an environment 100 for generating contents for a large language model, in accordance with an embodiment of the present disclosure. Environment 100 may include a content generation system 102, a client device 104, a network 106, data sources 108, and an LLM 120.

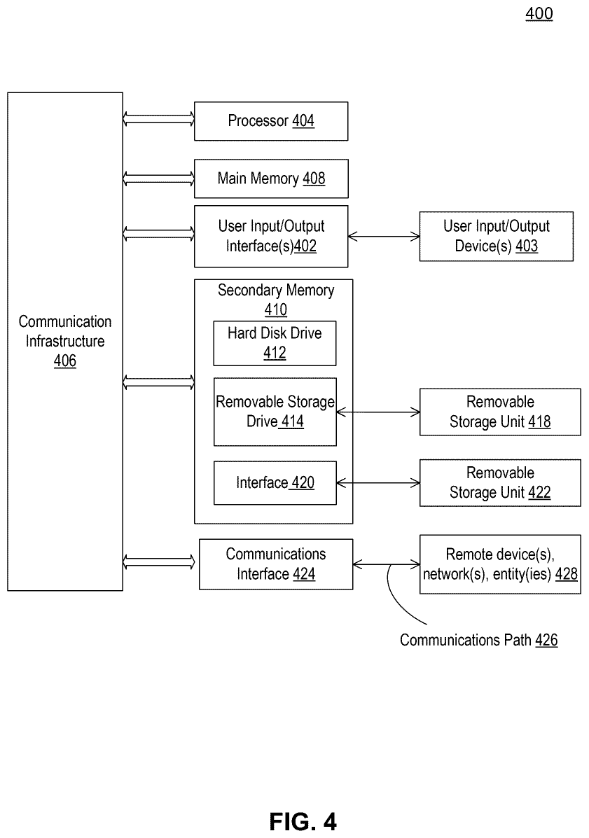

Content generation system 102 may operate on one or more servers and/or databases. The servers may be a variety of centralized or decentralized computing devices. For example, a server may be grid-computing resources, a virtualized computing resource, peer-to-peer distributed computing devices, a mobile device, a laptop computer, a desktop computer, or a combination thereof. The servers may be centralized in a single room, distributed across different rooms, distributed across different geographic locations, or embedded within network 106. In some aspects, content generation system 102 may be implemented using computer system 400 described with reference to FIG. 4.

Content generation system 102 may include a detection component 110, a theme component 112, a content generation component 114, a publication component 116, and a reinforcement learning component 118. Each component of detection component 110, theme component 112, content generation component 114, publication component 116, and reinforcement learning component 118 may be a computer system such as computer system 400 described with reference to FIG. 4.

In some aspects, detection component 110 may detect noise contents (e.g., misinformation). In some aspects, detection component 110 may receive an alert from client device 104 comprising the noise content. In some aspects, detection component 110 may use scanning techniques to detect the noise content. Examples of noise content include outdated information (e.g., an outdated website, an outdated logo, an outdated affiliation of a company or a person), fake news or incorrect information (e.g., a news article that includes factual errors about a company or a person). As one example of outdated information, detection component 110 may detect a change in a website associated with client device 104 (e.g., a service provider associated with client device 104 rebranding from a travel provider to an artificial intelligence provider, a change in the logo of the service provider). After detecting the change, detection component 110 may prompt LLM 120 to determine whether the response of LLM 120 comprises noise data. The prompt may be “what is the logo of company A?” If the response to the prompt comprise noise content (e.g., the old logo), then content generation system 102 may generate the corrective contents as further described below.

Theme component 112 may receive from detection component 110 the noise content. Theme component 112 may determine a theme (e.g., to counter the noise content). In some aspects, theme component 112 may receive a user input from client device 104 indicating the correct contents. In some aspects, theme component 112 may retrieve the correct contents from a trusted source (e.g., retrieve the new logo from an official website of the company). As described further below, using the theme, content generation system 102 may generate corrective contents. The theme may be used as a prompt by the content generation system 102 to generate the corrective contents. In the “outdated logo” example, the correct contents may correspond to the new logo. Theme component 112 may receive the new logo as a user input (e.g., as a digital image in an image file format) from client device 104. In this example, corrective contents may comprise a textual description of the new logo, various videos that show the new logo, a website showing the new logo, an article describing that the logo of company has changed. The corrective contents may be of different genres (forms) (e.g., blogs, videos, press releases, websites). After generating the corrective contents, content generation system 102 may feed the corrective contents into LLM 120. In some aspects, content generation system 102 may feed LLM 120 via API. In some aspects, the corrective contents is fed to LLM 120 by publishing the corrective contents via one or more channels. The one or more channels include data sources that the LLM 120 is likely to train on.

In order to identify the one or more channels, theme component 112 may crawl data sources 108 to determine a weight for each source of data sources 108. Theme component 112 may use a “crawler” to access data sources 108. Data sources 108 represent various sources such as websites, databases, APIs, and files where content is available and may be used to train LLM 120. In some aspects, theme component 112 may scan publicly available information across the World Wide Web in order to obtain an index for the content. The index may include metadata that comprises identification of each channel and the category of content provided by each channel. Theme component 112 may use the index to determine channel weights. The metadata includes the channel identification The channel weight may be expressed as a numerical score representing the share of the content from different sources (e.g., social media). Theme component 112 may determine a channel weight for each channel. In embodiments, the channel weights represent the amount of predicted influence that content from each respective channel will impact the output of the LLM 120. For example, LLM 120 may utilize channel weights for weighting the content from each channel when utilizing the content as input for training LLM 120.

Channels may be implemented as different sources for content and can be organized into the different categories or genres of the content provided by each channel, such as a social media channel, a professional social media channel, a video content channel, a personal text-based channel (e.g., a channel that allows users to post personal content that may include a combination of text and media), and a data source channel (e.g., a channel that is moderated, typically by a single entity, for providing information about different topics). For example, a channel weight of a social media channel may be 0.21, a channel weight of professional social media channel may be 0.03, a channel weight of video content channel may be 0.05, a channel weight of personal text-based channel may be 0.11, and a channel weight of a data source channel may be 0.03.

In addition, theme component 112 may determine a genre distribution of the content provided by the different channels. In some aspects, the genre may be videos, articles, and short messages. Theme component 112 may determine the percentage of content that belong to each genre. For example, videos may represent 40%, articles may represent 30%, and short messages may represent 30% of the content. Each of the genre may be further divided into sub-categories. For example, videos may be further divided into interviews, cartoon shows, introduction videos, advertisement videos, and the like. The percentage of each sub-category may also be determined using the index of the content. For example, interviews may represent 30% of the video, cartoon shows may represent 20%, introduction videos may represent 15%, and advertisement videos may represent 10% of the video contents. Similarly, articles may comprise different sub-categories. The sub-categories may include news, scientific articles, tutorials, and the like. The percentage of each categories may also be determined. News may represent 30%, scientific articles may represent 20%, and tutorials may represent 10% of the articles. Short messages content may be further divided into the following categories: short-form messages, merchant reviews, chats, and the like. Tweets may represent 30% of the short messages content, merchant reviews may represent 20%, and chats may represent 10% of short messages.

In some aspects, content generation component 114 may use the genre distribution as a target genre distribution for the corrective contents. The genre distribution may be received by content generation component 114 from theme component 112. Content generation component 114 may prompt an artificial intelligence (AI) model to generate contents according to the target genre distribution. In some aspects, content generation component 114 may prompt LLM 120 to generate the contents according to the target genre distribution determined by theme component 112.

In some aspects, content generation component 114 may generate a prompt to the AI model based on the theme, the genre distribution, and/or any other parameters. The prompt may include the theme and the genre distribution. As discussed above, the theme may include the correct content (e.g., the new logo). The prompt may include the new logo and the target or desired genre distribution for the corrective contents. The prompt may also include additional parameters such as a length of videos in the corrective contents, a limit on the number of words in articles, and other desired parameters. The prompt includes a request (instruction) for the AI to generate contents based on the theme. For example, the prompt may be “generate contents that show the new logo for company A according to the following genre distribution.” The prompt may also include one or more parameters. For example, “limit articles describing the new logo to 500 words.” Then, the AI model may generate contents that can be used as the corrective contents as they include the correct contents.

In another example, the prompt may be “generate contents indicating that the platinum card is no longer offered by company A.” The prompt may also include the genre distribution. For example, the prompt may also include “generate the contents with the following distribution: 20% of videos, 20% of articles, and 60% of short messages.” The prompt may also include a duration of the desired video content.

Publication component 116 may broadcast the generated corrective contents according to the channel weights determined by theme component 112. In some aspects, publication component 116 may broadcast the contents via publicly available channels. For example, an account associated with content generation system 102 for a social channel may be used to publish the corrective content on the social channel. In some aspects, the corrective contents are published with a corresponding signature and declaration. For non-publicly accessible or restricted channels, the corrective contents may be published on a website associated with content generation system 102. In some embodiments, content generation system 102 will generate one or more publicly available websites that are similar to the non-publicly accessible or restricted channel. Content generation system 102 may generate the structure of the websites corresponding to each channel, according to the channel weights. The channel weights impact how the corrective content may be published to mirror the influence indicated by the respective channel weights. For example, the mirror publicly available website for a non-publicly accessible or restricted channel that has a higher channel weight may be featured first within the structure of the websites so that the corrective content published on the mirror publicly available website has greater influence when retraining a model.

The structure of such websites are automatically generated by the content generation system 102 according to the channel weights generated by theme component 112. The website may be accessed from a link available on a website of the content generation system 102.

In some aspects, upon inputting corrective contents, inquires, and correct knowledge through content generation system 102, the LLM 120 outputs and responses are updated to respond with the correct information (e.g., without noise content). As described further below, content generation system 102 may monitor the responses of the LLM 120 to determine whether the corrective contents are effective.

Reinforcement learning component 118 may determine whether broadcasting the corrective contents is successful in correcting the noise content (e.g., whether the misinformation is corrected). Reinforcement learning component 118 may determine an effectiveness metric and modify channel weights and/or a publishing schedule to improve the effectiveness metric. In some aspects, reinforcement learning component 118 may establish a predefined set of queries for LLM 120 and record the responses of LLM 120 to the queries before and after the generated corrective contents are broadcasted. The change in the responses is monitored and is used to drive reinforcement learning. For example, a query to LLM 120 may be “what are the types of cards offered by company A?”, “is the platinum card still offered by company A?”, “what is the logo of company A?” or “describe the logo of company A.” The change in the responses may reflect changes in the accuracy or correctness of the responses from LLM 120. The change in the accuracy and correctness may be determined by content generation system 120 based on the predefined set of queries and expected outputs to the predefined set of queries. In some embodiments, the effectiveness metric is generated reflecting the change in the before and after responses. In some embodiments, there may be different predefined sets of queries for testing different channels (e.g., social media channel, professional social media channel, personal text-based channel).

The reinforcement component 118 may compare the response to the queries with the correct content to determine whether the corrective contents is effective. For example, the channel weights may be adjusted based on their effectiveness metrics. An example of adjusting channel weights may include increasing the channel weight if it is determined that the effectiveness metric for corrective content of a particular channel exceeds a threshold amount (e.g., is considered to be very effective at influencing or changing the output of LLM 120). As another example, adjusting channel weights may include decreasing the channel weight it is determined the effectiveness metric for corrective content of a particular channel is below the threshold amount (e.g., is considered to be not effective). Reinforcement learning component 118 may adjust the channel weights if the corrective contents was not effective (e.g., the response to the query “what is the logo of company A?” is the old logo). The adjusted channel weights may be used for future broadcast of contents. In some aspects, excess corrective contents may be removed (e.g., when the channel weight is lowered by reinforcement learning component 118).

In some aspects, the corrective contents generated by content generation component 114 may be published by publication component 116 following a publishing schedule (e.g., at preset intervals). The publishing schedule may correspond to when a provider of LLM 120 updates the data source (e.g., one day, two days, . . . , 30 days). In some aspects, the schedule at which the provider of LLM 120 updates the data source is unknown to content generation system 102. Reinforcement learning component 118 may update the publishing schedule. Reinforcement learning component 118 may compare response before and after broadcasting and determine the effectiveness of broadcasting the corrective contents. Reinforcement learning component may adjust the publishing schedule based on the effectiveness. The effectiveness may be measured by determining the similarity or dissimilarity of the responses. The adjusted schedule may be used when broadcasting the corrective contents.

In some aspects, content generation system 102 may output a notification to client device 104 indicating that the corrective action is performed and the status of the corrective action (e.g., whether the corrective action is successful).

Client device 104 may be associated with a service provider (e.g., a merchant) or a user. Client device 104 may be a computer system such as computer system 400 described with reference to FIG. 4. For example, client device 104 may be any variety of electronic devices, such as a mobile device (e.g., smartphone, tablet, pager, personal digital assistant (PDA)), a computer (e.g., a laptop computer, a desktop computer, a server), and/or a wearable device (e.g., a smartwatch). Client device 104 may include one or more processors and/or memory. Client device 104 may interact with content generation system 102 to submit receive an alert comprising the noise content and may receive confirmation that the misinformation is successfully corrected.

Client device 104 may comprise an interface for presenting and/or receiving information to/from a user. An interface may be a communication interface such as a command window, a web browser, a display, and/or any other type of interface. Other software, hardware, and/or interfaces may be used to provide communication between the user and content generation system 102. For example, the interface may be a web portal that provides a web page or website to the user for viewing and interaction. The web portal may be located at a web address accessible via a web browser, and may be supported by one or more servers (e.g., computer system 400 as further described with reference to FIG. 4). The website may be a graphical user interface (GUI) provided by content generation system 102 and/or via an application programing interface (API) provided by content generation system 102.

As used herein, the API may comprise any software capable of performing an interaction between one or more software components as well as interacting with and/or accessing one or more data storage elements (e.g., server systems, databases, hard drives, and the like). An API may comprise a library that specifies routines, data structures, object classes, variables, and the like. Thus, an API may be formulated in a variety of ways and based upon a variety of specifications or standards, including, for example, POSIX, the MICROSOFT WINDOWS API®, a standard library such as C++, a JAVA API, and the like.

Network 106 refers to a telecommunications network, such as a wired or wireless network. Network 106 can span and represent a variety of networks and network topologies. For example, network 106 can include wireless communication, wired communication, optical communication, ultrasonic communication, or a combination thereof. For example, satellite communication, cellular communication, Bluetooth, Infrared Data Association standard (IrDA), wireless fidelity (WiFi), and worldwide interoperability for microwave access (WiMAX) are examples of wireless communication that may be included in network 106. Cable, Ethernet, digital subscriber line (DSL), fiber optic lines, fiber to the home (FTTH), and plain old telephone service (POTS) are examples of wired communication that may be included in the network 106. Further, network 106 can traverse a number of topologies and distances. For example, network 106 can include a direct connection, personal area network (PAN), local area network (LAN), metropolitan area network (MAN), wide area network (WAN), or a combination thereof.

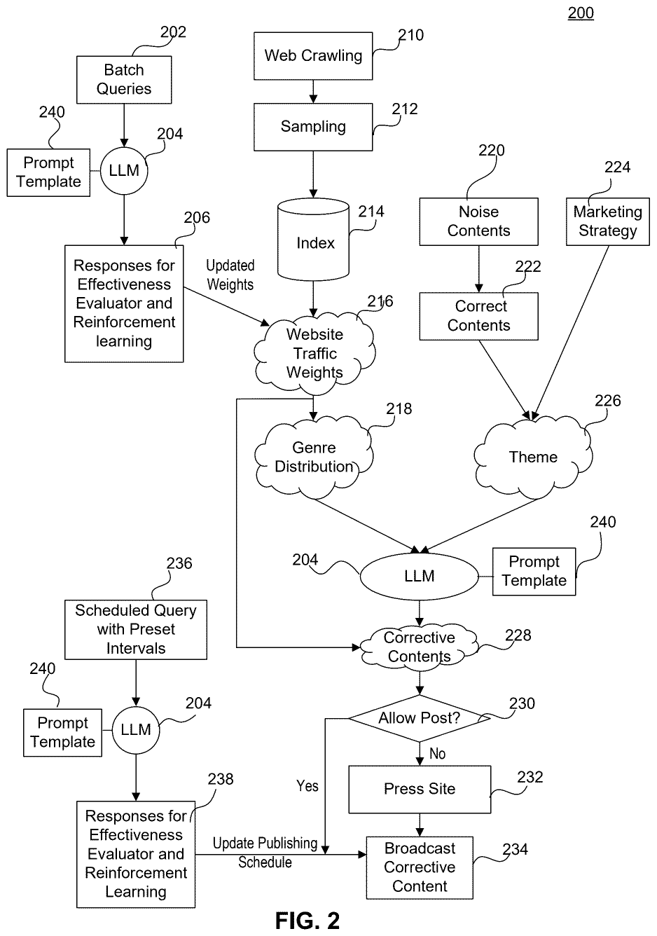

FIG. 2 is a diagram that shows a processing flow 200 for generating and publishing corrective contents for LLM models, in accordance with an embodiment of the present disclosure.

Content generation system 102 may identify noise content 220 (e.g., misinformation). Content generation system 102 may identify noise content 220 based on an input received from client device 104. In some aspects, content generation system 102 may crawl data sources 108 to detect whether noise data exists. For example, content generation system 102 may compare data from a trusted source with other data sources (e.g., data included on the official website of company A may be compared with data from other sources (e.g., blogs) that are not affiliated with company A). In some aspects, noise content 220 may be identified automatically by a digital assistant (e.g., a bot, a digital agent) of client device 104. For example, if digital assistant receives a question regarding a no longer existing product or a service that is no longer offered by a company, digital agent may transmit a request to content generation system 102 indicating the noise content.

Content generation system 102 may identify correct content 222 based on the noise content 220. In some aspects, content generation system 102 may receive a user input from client device 104 indicating the correct claims. In some aspects, correct contents 222 may be retrieved from a trusted source associated with the client device 104 (e.g., official website of a service provider).

Content generation system 102 may determine a theme 226. Theme 226 may be based on correct contents 222. In addition, content generation system 102 may acquire an input indicating a marketing strategy 224. Content generation system 102 may identify theme 226 based on marketing strategy 224 and/or correct contents 222. Marketing strategy 224 may be generated by an AI model. Marketing strategy 224 may comprise a key message of the service provider, a target audience of the service provider, customer personas, and the like. The marketing strategy may include keywords and topics that may be included with the correct contents 222. For example, the keywords and topics may include a new product or a new service. Theme 226 may include the new product or new service. For example, a prompt that includes marketing strategy 224 and correct contents 222 may be “generate contents that indicate that the platinum card is no longer offered by company and highlight that a new gold card is being offered.” In some aspects, content generation system 102 may use a prompt template 240.

Content generation system 102 may use a LLM 204 to generate corrective contents 228. LLM 204 may generate corrective contents 228 based on theme 226 and genre distribution 218. A prompt to LLM 204 to generate corrective contents 228 may include theme 226 and genre distribution 218. The prompt may also include additional parameters as discussed above such a duration or length of the contents. Content generation system 102 may generate the prompt to LLM 204 to generate the corrective contents. Continuing with the above example, the prompt may be “generate contents indicting that the platinum card is no longer offered by company A.” The prompt may also include genre distribution 218. For example, the prompt may also include “generate the contents with the following distribution: 20% of videos, 20% of articles, and 60% of short messages.” The prompt may also include a duration of the desired video content.

Content generation system 102 may use prompt template 240 to generate various prompts for LLM 204. Content generation system 102 may use prompt template 240 to prompt LLM 204 to generate corrective contents 228. In addition, content generation system 102 may use prompt template 240 to generate queries for LLM 204 to determine whether the corrective contents are effective as described further below, or to compare contents.

After generating the corrective contents 228, content generation system 102 may broadcast corrective contents 228 using one or more channels. Corrective contents 228 may be published based on channel weights. The channel weights may also be based on website traffic weights 216. Channel weights may be based on analytics of LLM behavior and likely sources for data.

In some aspects, a feedback loop may be implemented to determine whether corrective contents 228 are valid and ready to be broadcasted. For example, the corrective contents 228 may be compared with correct contents 222 to determine whether the corrective contents are similar to the correct contents. If the corrective contents are similar to the correct contents, then the corrective contents are valid and are ready to be broadcasted by publication component 116. In some aspects, LLM 204 may be used to compare the corrective contents 228 and the correct contents 222. For example, a prompt may be generated for the LLM 204 to compare correct contents 222 and corrective contents 228. Content generation system 102 may use prompt template 240 to generate the prompt for LLM 204. For example, correct contents 222 and corrective contents 228 are fed to LLM 204 in the prompt. LLM 204 converts correct contents 222 and corrective contents 228 into embeddings that represent the semantic meaning of each content. LLM 204 may determine a similarity between the embeddings. If the similarity is above a threshold, then the corrective contents 228 are valid and content generation system 102 may broadcast corrective contents 228. If the similarity is below the threshold, the corrective contents are not broadcasted and may be regenerated by modifying the prompt.

In some aspects, LLM 204 may be a targeted LLM specially trained to generate corrective contents. The prompt to generate the corrective contents may be generated by a digital assistant (e.g., a digital agent, a bot). In addition, the prompt may be generated or refined based on user inputs received by the content generation system 102. For example, LLM 204 may generate the prompt and output the prompt to client device 104. Content generation system 102 may use prompt template 240 to generate the prompt. User inputs may be sent from the client device 104 to content generation system 102. Content generation system 102 may refine the prompt based on the user inputs. For example, a parameter such as a maximum duration of the videos may be specified by the user inputs. In other aspects, LLM 204 may be a general purpose LLM.

As discussed above, corrective contents 228 may be generated based on a target genre distribution. Target genre distribution may correspond to genre distribution 218. For example, the prompt may include genre distribution 218. For example, the prompt may include “generate the contents with the following distribution: 20% of videos, 20% of articles, and 60% of short messages. Genre distribution 218 may be determined based on an index 214 that stores information such as metadata about contents of website.

In order to determine index 214, content generation system 102 may crawl different data sources (e.g., data sources 108). For example, content generation system 102 may crawl web sources to obtain web crawling data 210. Content generation system 102 may sample web crawling data 210 to obtain sample data 212. Then, content generation system 102 may determine index 214 based on sample data 212. During indexing, content generation system 102 may analyze content of sample data 212 to determine its content and genre of contents. As discussed above, content generation system 102 may determine website traffic weights 216 based on index 214. In addition, content generation system 102 may update the website traffic weights 216 based on information received from reinforcement learning component 118 to improve the effectiveness of corrective contents 228. The website traffic weights 216 may be updated using reinforcement learning technique algorithm. Reinforcement learning techniques may determine one of two states “successful” or “not successful” for the website traffic weights 216 and may adjust the website traffic weights 216 through trial and error.

In some embodiments, website traffic weights 216 may be an embodiment of channel weights, with each website representing a channel (e.g., a social media website, a professional social media website, a personal text-based messaging website, a data source website). Website traffic weights 216 may be adjusted (e.g., increased or decreased) similarly to channel weights, with each adjustment impacting the amount of influence content from each website may have in retraining the LLM 204.

To determine the effectiveness of contents 228, content generation system 102 may generate a set of queries 202. Content generation system 102 may prompt LLM 204 using the set of queries 202 to obtain responses 206. The set of queries may include prompts that may output noise data if the corrective contents are not successful. For example, the set of queries may include “what are the types of cards that are currently being offered by company A?” Based on responses 206, updated weights are determined by reinforcement learning component 118.

In some aspects, channel weights may be determined based on a type of the LLM that is being influenced to train on corrective contents 228. For example, models such as general purpose LLMs are trained on a large number of content from a large number of websites. Other more specialized LLM (are trained on more specific contents compared to general purpose LLMs Open source LLMs publish their data source. Thus, content generation system 102 may adjust the weight of the channels based on the published sources. For example, if an LLM model for travel recommendations is trained on contents from the top 50 travel websites. Content generation system 102 may publish corrective contents 228 using the top 50 travel websites in order to influence the LLM model for travel recommendations. For closed source LLMs, data sources for training may not be available and channel weights may be adjusted using reinforcement learning component 118 as described previously herein.

In some aspects, content generation system 102 may determine a publishing schedule to broadcast corrective contents 228. Content generation system 102 may modify the schedule if the publishing schedule does not provide the desired corrective action. In order to determine whether the publishing schedule is effective, content generation system 102 may prompt LLM 204 using one or more queries at preset intervals 236 to obtain responses 238. Reinforcement learning component 118 may adjust the publishing schedule using a reinforcement learning algorithm.

In order to publish the corrective contents 228, content generation system 102 may determine whether the channel is publicly accessible at 230. In response to determining that the channel is publicly accessible, content generation system 102 may broadcast corrective contents 228 according to the publishing schedule or the updated publishing schedule in 234. For example, for publicly accessible social channel, corrective contents 228 may be published through a profile associated with content generation system 102 or a profile associated with client device 104. In response to determining that the channel is not publicly accessible (e.g., does not allow additional comments on a post), content generation system 102 may generate a press site 232. Corrective contents 228 are published on a webpage of press site 232.

In some aspects, content generation system 102 may incentivize LLM 204 to train on corrective contents 228. For example, a reward may be offered to the first LLM that picks up a target content that include corrective contents 228. For example, a limited time offer may be offered so LLM 204 is incentivized to grab from that source and the content (including corrective contents 228) is delivered to users of the LLM.

In some aspects, LLM 204 may be prompted to generate the corrective contents multiple times. Some LLMs may continuously train based on the received queries or prompts. Thus, the prompt acts as a training source for LLM 204 and the corrective contents 228 influence the training of LLM 204 and reduce noise content 220.

### Methods of Operation

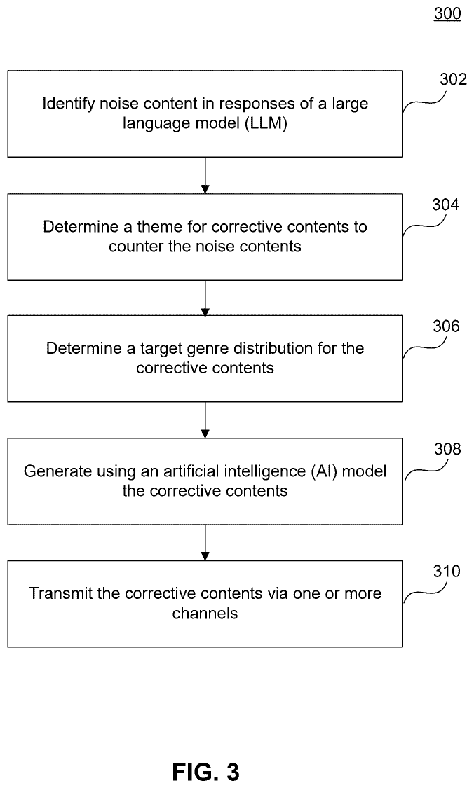

FIG. 3 is an example method 300 for retraining a trained machine learning models using hybrid generated contents, in accordance with an embodiment of the present disclosure. Method 300 may be performed as a series of steps by a computing unit such as a processor. For example, method 300 may be implemented by content generation system 102 and/or computer system 400 of FIG. 4. Method 300 shall be described with reference to FIG. 1, however, method 300 is not limited to that example embodiment.

In 302, content generation system 102 may identify noise content in outputs of a LLM. The output of the LLM may be a response to a query. Content generation system 102 may identify noise content based on input received from client device 104. In some aspects, content generation system 102 may identify noise contents by comparing data from trusted sources with information in outputs of the LLM.

In 304, content generation system 102 may determine a theme for corrective contents to counter the noise contents. The theme for corrective contents may include correct contents 222 and/or marketing strategy 224. In some aspects, correct contents may be received by content generation system 102 as user inputs from client device 104. For example, content generation system 102 may receive a digital image corresponding to the new logo if the noise data comprised an outdated logo. In another example, content generation system 102 may receive a list of the current services offered by the company or service provider.

In 306, content generation system 102 may determine a target genre distribution for the corrective contents. In some aspects, the target genre distribution may correspond to a genre distribution of a sample of contents obtained by scanning data sources that comprise contents used in training the LLM. The genre distribution may be a percentage of a classification of the sample of contents. Example of content includes multimedia content such as any combination of video content, audio content, and text content, as well as text-based content, such as websites, data sources, text messages, short messages. For example, content generation system 102 may determine the classification of the sample contents as 20% videos, 30% articles, and 60% short messages. The classification of the sample contents may be determined based on metadata associated with the sample contents and retrieved when scanning the data sources.

In 308, content generation system 102 may generate a prompt to an artificial intelligence model to generate the corrective contents. Content generation system 102 may generate the corrective contents based on the target genre distribution and the theme. The prompt may include the theme and the target genre distribution. The prompt may include a request to the artificial intelligence model to generate contents having the theme determined by theme component 112. In some aspects, content generation system 102 may prompt LLM 120 to generate the corrective contents.

In 310, content generation system 102 may broadcast, by the at least one computing device, the corrective contents via one or more channels. In some aspects, content generation system 102 may determine channel weights that indicates a distribution of the sample of contents across the one or more channels. In some aspects, the corrective contents is broadcasted via the one or more channels based on the weights. For example, if a first social channel has a weight of 0.6 and a second social channel has a weight of 0.4, 60% of the corrective contents are broadcasted using the first social channel and 40% of the corrective contents are broadcasted over the second social channel.

In some aspects, before transmitting the corrective contents using the one or more channels, content generation system 102 may query the LLM to obtain a first set of responses. Then, content generation system 102 may query the LLM to obtain a second set of responses after publishing the corrective contents using the one or more channels. In some aspects, content generation system 102 may determine effectiveness metric based on a comparison between the first set of responses and the second set of responses and update the channel weights based on the effectiveness metric. For example, the effectiveness metric may measure a dissimilarity between the first set of responses and the second set of responses. The dissimilarity may be obtained by feeding the first set of responses and the second set of responses to an artificial training model. A high dissimilarity may indicate that the corrective contents is effective and that the channel weights are not updated. A low dissimilarity may indicate that the corrective contents is not effective and the channel weights are adjusted by reinforcement learning component 118.

It is to be appreciated that not all steps may be needed to perform the disclosure provided herein. Further, some of the steps may be performed simultaneously, or in a different order than shown in FIG. 3, as will be understood be a person of ordinary skill in the art.

### Components of the System

Various embodiments of content generation system 102 may be implemented, for example, using one or more well-known computer systems, such as computer system 400 shown in FIG. 4. For example, one or more computer systems 400 may be used, for example, to implement one or more components of content generation system 102 (e.g., detection component 110, theme component 112, content generation component 114, publication component 116, and reinforcement learning component 118) discussed herein, as well as combinations and sub-combinations thereof.

Computer system 400 may include one or more processors (also called central processing units, or CPUs), such as a processor 404. Processor 404 may be connected to a communication infrastructure or bus 406.

Computer system 400 may also include user input/output device(s) 403, such as monitors, keyboards, pointing devices, etc., which may communicate with communication infrastructure 406 through user input/output interface(s) 402.

One or more of processors 404 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 400 may also include a main or primary memory 408, such as random access memory (RAM). Main memory 408 may include one or more levels of cache. Main memory 408 may have stored therein control logic (i.e., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, tape backup device, and/or any other storage device/drive.

Removable storage drive 414 may interact with a removable storage unit 418. Removable storage unit 418 may include a computer usable or readable storage device having stored thereon computer software (control logic) and/or data. Removable storage unit 418 may be a floppy disk, magnetic tape, compact disk, DVD, optical storage disk, /d/ any other computer data storage device. Removable storage drive 414 may read from and/or write to removable storage unit 418.

Secondary memory 410 may include other means, devices, components, instrumentalities or other approaches for allowing computer programs and/or other instructions and/or data to be accessed by computer system 400. Such means, devices, components, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 400 may further include a communication or network interface 424. Communication interface 424 may enable computer system 400 to communicate and interact with any combination of external devices, external networks, external entities, etc. (individually and collectively referenced by reference number 428). For example, communication interface 424 may allow computer system 400 to communicate with external or remote devices 428 over communications path 426, which may be wired and/or wireless (or a combination thereof), and which may include any combination of LANs, WANs, the Internet, etc. Control logic and/or data may be transmitted to and from computer system 400 via communication path 426.

Computer system 400 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 400 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (Saas), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 400 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 400, main memory 408, secondary memory 410, and removable storage units 418 and 422, as well as tangible articles of manufacture embodying any combination of the foregoing. Such control logic, when executed by one or more data processing devices (such as computer system 400), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 4. In particular, embodiments can operate with software, hardware, and/or operating system implementations other than those described herein.

The terms “component” or “unit” referred to in this disclosure can include software, hardware, or a combination thereof in an aspect of the present disclosure in accordance with the context in which the term is used. For example, the software may be machine code, firmware, embedded code, or application software. Also for example, the hardware may be circuitry, a processor, a special purpose computer, an integrated circuit, integrated circuit cores, or a combination thereof. Further, if a component or unit is written in the system or apparatus claims section below, the component or unit is deemed to include hardware circuitry for the purposes and the scope of the system or apparatus claims.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

1. A computer implemented method, comprising:
identifying, by at least one computing device, noise content in responses of a large language model (LLM);
determining, by the at least one computing device, a theme for corrective contents to counter the noise contents;
determining, by the at least one computing device, a target genre distribution for the corrective contents;
generating, by the at least one computing device and using an artificial intelligence (AI) model, the corrective contents based on the target genre distribution and the theme, wherein the corrective contents comprise contents of different genres based on the target genre distribution;
broadcasting, by the at least one computing device, the corrective contents via one or more channels; and
retraining the LLM using the corrective contents.

2. The computer implemented method of claim 1, further comprising:
scanning data sources to obtain a sample of contents; and
determining the target genre distribution based on a genre distribution of the sample of contents.

3. The computer implemented method of claim 2, wherein the genre distribution indicates a percentage of a classification of the sample of contents into a plurality of genres, wherein the plurality of genres includes at least one of a video, a short message, or a text-based message.

4. The computer implemented method of claim 2, further comprising:
determining channel weights, wherein the channel weights correspond to a distribution of the sample of contents across the one or more channels; and
transmitting the corrective contents via the one or more channels based on the channel weights.

5. The computer implemented method of claim 4, further comprising:
before transmitting the corrective contents using the one or more channels, querying the LLM to obtain a first set of responses;
after publishing the corrective contents using the one or more channels, querying the LLM to obtain a second set of responses;
determining an effectiveness metric based on a comparison between the first set of responses and the second set of responses; and
updating the channel weights based on the effectiveness metric.

6. The computer implemented method of claim 1, further comprising:
querying the AI model at preset intervals;
determining an effectiveness metric for the corrective contents; and
adjusting a publishing schedule for the corrective contents based on the effectiveness metric.

7. The computer implemented method of claim 6, wherein the adjusting is based on a reinforcement learning algorithm.

8. The computer implemented method of claim 1, further comprising:
publishing the corrective contents via a webpage of a publicly accessible website.

9. A system, comprising:
a memory; and
at least one processor coupled to the memory and configured to:
identify noise content in responses of a large language model (LLM);
determine a theme for corrective contents to counter the noise contents;
determine a target genre distribution for the corrective contents;
generate, using an artificial intelligence (AI) model, the corrective contents based on the target genre distribution and the theme, wherein the corrective contents comprise contents of different genres based on the target genre distribution;
broadcast the corrective contents via one or more channels; and
retrain the LLM using the corrective contents.

10. The system of claim 9, wherein the at least one processor is further configured to:
scan data sources to obtain a sample of contents; and
determine the target genre distribution based on a genre distribution of the sample of contents.

11. The system of claim 10, wherein the genre distribution indicates a percentage of a classification of the sample of contents into a plurality of genres, wherein the plurality of genres includes at least one of a video, a short message, or a text-based message.

12. The system of claim 10, wherein the at least one processor is further configured to:
determine channel weights, wherein the channel weights correspond to a distribution of the sample of contents across the one or more channels; and
transmit the corrective contents via the one or more channels based on the channel weights.

13. The system of claim 12, wherein the at least one processor is further configured to:
query the LLM to obtain a first set of responses before transmitting the corrective contents using the one or more channels;
query the LLM to obtain a second set of responses responsive to publishing the corrective contents using the one or more channels;
determine an effectiveness metric based on a comparison between the first set of responses and the second set of responses; and
update the channel weights based on the effectiveness metric.

14. The system of claim 9, wherein the at least one processor is further configured to:
query the AI model at preset intervals;
determine an effectiveness metric for the corrective contents; and
adjust a publishing schedule for the corrective contents based on the effectiveness metric.

15. The system of claim 14, wherein the adjusting is based on a reinforcement learning algorithm.

16. The system of claim 9, wherein the at least one processor is further configured to:
publish the corrective contents via a webpage of a publicly accessible website.

17. A non-transitory computer-readable device having instructions stored thereon that, when executed by at least one computing device, cause the at least one computing device to perform operations comprising:
identifying noise content in responses of a large language model (LLM);
determining a theme for corrective contents to counter the noise contents;
determining a target genre distribution for the corrective contents;
generating, using an artificial intelligence (AI) model, the corrective contents based on the target genre distribution and the theme, wherein the corrective contents comprise contents of different genres based on the target genre distribution;
broadcasting the corrective contents via one or more channels, and
retraining the LLM using the corrective contents.

18. The non-transitory computer-readable device of claim 17, wherein the operations further comprise:
scanning data sources to obtain a sample of contents; and
determining the target genre distribution based on a genre distribution of the sample of contents.

19. The non-transitory computer-readable device of claim 18, wherein the operations further comprise:
determining channel weights, wherein the channel weights correspond to a distribution of the sample of contents across the one or more channels; and
transmitting the corrective contents via the one or more channels based on the channel weights.

20. The non-transitory computer-readable device of claim 17, wherein the operations further comprise:
querying the AI model at preset intervals;
determining an effectiveness metric for the corrective contents; and
adjusting a publishing schedule for the corrective contents based on the effectiveness metric.
